(19) United States
(12) Patent Application Publication
(10) Pub. No.: US 2025/0021930 A1
(43) Pub. Date: Jan. 16, 2025

(54) SYSTEM AND METHOD OF INVENTORY MANAGEMENT

(71) Applicant: AA COLLECTABLES, INC. d/b/a AA Mint Cards, Davie, FL (US)

(72) Inventors: MARK AMARANT, Davie, FL (US); AARON AMARANT, Davie, FL (US); KEVIN COLLINS, Davie, FL (US)

(21) Appl. No.: 18/352,452

(22) Filed: Jul. 14, 2023

(51) Int. Cl. G06Q 10/087; G06Q 20/20; G06Q 30/0601

(52) U.S. Cl. CPC G06Q 10/087; G06Q 20/203; G06Q 30/0639; G06Q 30/0643

(57) ABSTRACT

A system for inventory management of a one-of-a-kind product with a single quantity includes at least one physical store for displaying the product for sale in a physical slot of a grid, one or more online sales platforms to list a product identifier associated with the product, and an inventory database to associate and store product information of the product with the product identifier. The system includes an inventory management server to generate a webpage including a graphical representation of the grid including a plurality of virtual slots corresponding to the physical slots in the grid, receive position data of the physical slot having the product inserted, and overlay an image of the product on a virtual slot corresponding to the physical slot. The inventory management server further displays the webpage with the image of the product overlaid on the virtual slot and update the trading status of the product.

### BACKGROUND OF THE INVENTION

Inventory management plays a crucial role in today's market, particularly when a product is listed for sale across multiple sales channels, such as online and physical stores. It is important to maintain records and consistently update the inventory when purchases are made from these sales channels. Maintaining the records and updating the inventory across all sales channels becomes even more crucial when the product is a one-of-a-kind product with a single quantity. Any delay in updating the inventory or a lack of synchronization between the sales channels can lead to unintended consequences, such as unknowingly accepting multiple orders for the same product. Such oversights can result in stockouts, overselling, dissatisfied customers, and/or potential revenue loss.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a block diagram of a system for inventory management of a one-of-a-kind product with a single quantity, in accordance with some embodiments;

FIG. 2 is a block diagram of an inventory management server for use within the system of FIG. 1, in accordance with some embodiments;

FIG. 3 is a block diagram of a user device for use within the system of FIG. 1, in accordance with some embodiments;

FIG. 4 illustrates a grid with multiple physical slots in a physical store of FIG. 1, in accordance with some embodiments;

FIG. 5 illustrates a graphical representation of the grid displayed on the user device, in accordance with some embodiments;

FIG. 6 is a process diagram for listing the product on one or more online sales platforms and a Point of Sale (POS) system, in accordance with some embodiments;

FIG. 7 is a process diagram for updating a trading status of the product on the one or more online sales platforms and the POS system, in accordance with some embodiments; and

FIG. 8 is a method for inventory management of the product, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The apparatus and method components have been represented where appropriate by conventional symbols in the drawings, showing only those specific details that are pertinent to understanding the embodiments so as not to obscure the description with details that will be readily apparent to those of ordinary skill in the art having the benefit of the description herein.

### DETAILED DESCRIPTION OF THE INVENTION

In one aspect, a system for inventory management of a one-of-a-kind product with a single quantity across at least one physical store and one or more online sales platforms is described. The system includes the at least one physical store for displaying the product for sale. The at least one physical store includes a grid with multiple physical slots and the product is inserted in a physical slot of the multiple physical slots in the grid for display. The system further includes the one or more online sales platforms, each of the one or more online sales platforms configured to list a product identifier associated with the product for sale on their respective websites. The method further includes an inventory database configured to associate and store product information of the product with the product identifier. The product information includes a trading status and physical location of the product and the physical location indicates position data of the physical slot in the grid. The system further includes an inventory management server communicatively coupled to the inventory database and the one or more online sales platforms. The inventory management server is configured to generate a webpage including a graphical representation of the grid of the physical store. The graphical representation includes a plurality of virtual slots corresponding to the multiple physical slots in the grid and the positioning of each of the plurality of virtual slots in the webpage corresponds to the actual positioning of the corresponding multiple physical slots in the grid. The inventory management server is further configured to receive position data of the physical slot having the product inserted and overlay an image of the product on a virtual slot of the plurality of virtual slots in the webpage corresponding to the physical slot. The inventory management server is further configured to display, on a user device, the webpage with the image of the product overlaid on the virtual slot of the webpage upon receiving a request from the user device and update the trading status of the product associated with the product identifier on the one or more online sales platforms and in the inventory database when the product is sold in any one of the online platforms or the physical store. The updating the trading status includes removing the image of the product from the virtual slot of the webpage displayed on the user device.

In another aspect, a method for inventory management of a one-of-a-kind product with a single quantity across at least one physical store and one or more online sales platforms is described. The method includes displaying, at the at least one physical store, the product for sale. The at least one physical store includes a grid with multiple physical slots and the product is inserted in a physical slot of the multiple physical slots in the grid for display. The method further includes associating and storing, in an inventory database, product information of the product with the product identifier. The product information including a trading status and physical location of the product and the physical location indicates position data of the physical slot in the grid. The method further includes listing, on the one or more online sales platforms, the product identifier associated with the product for sale on their respective websites and generating, by an inventory management server, a webpage including a graphical representation of the grid of the physical store. The graphical representation includes a plurality of virtual slots corresponding to the multiple physical slots in the grid and the positioning of each of the plurality of virtual slots in the webpage corresponds to the actual positioning of the corresponding multiple physical slots in the grid. The method further includes receiving, by the inventory management server, position data of the physical slot having the product inserted and overlaying, by the inventory management server, an image of the product on a virtual slot of the plurality of virtual slots in the webpage corresponding to the physical slot. Further, the method includes displaying, by the inventory management server, on a user device, the webpage with the image of the product overlaid on the virtual slot of the webpage upon receiving a request from the user device and updating, by the inventory management server, the trading status of the product associated with the product identifier on the one or more online sales platforms and in the inventory database when the product is sold in any one of the online platforms or the physical store. The updating the trading status includes removing the image of the product from the virtual slot of the webpage displayed on the user device.

In yet another aspect, an inventory management server for inventory management of a one-of-a-kind product with a single quantity across at least one physical store and one or more online sales platforms is described. The inventory management server includes an inventory management server memory configured to store one or more instructions and an inventory management server processor communicatively coupled to the inventory management server memory. The inventory management server processor is configured to execute the one or more instructions stored in the inventory management server memory to provide instructions to list a product identifier associated with the product for sale on the one or more online sales platforms. The inventory management server processor is further configured to associate and store, in an inventory database, product information of the product with the product identifier. The product information includes a trading status and physical location of the product. The physical location indicates position data corresponding to a location of a physical slot associated with the product in a grid of the at least one physical store. The inventory management server processor is further configured to generate a webpage including a graphical representation of the grid of the physical store. The graphical representation includes a plurality of virtual slots corresponding to multiple physical slots in the grid and the positioning of each of the plurality of virtual slots in the webpage corresponds to actual positioning of the corresponding multiple physical slots in the grid. The inventory management server processor is further configured to receive position data of the physical slot associated with the product, overlay an image of the product on a virtual slot of the plurality of virtual slots in the webpage corresponding to the physical slot, and display the webpage with the image of the product overlaid on the virtual slot of the webpage on a user device upon receiving a request from the user device. The inventory management server processor is further configured to update the trading status of the product associated with the product identifier on the one or more online sales platforms and in the inventory database when the product is sold in any one of the online platforms or the physical store. The updating the trading status includes removing the image of the product from the virtual slot of the webpage displayed on the user device.

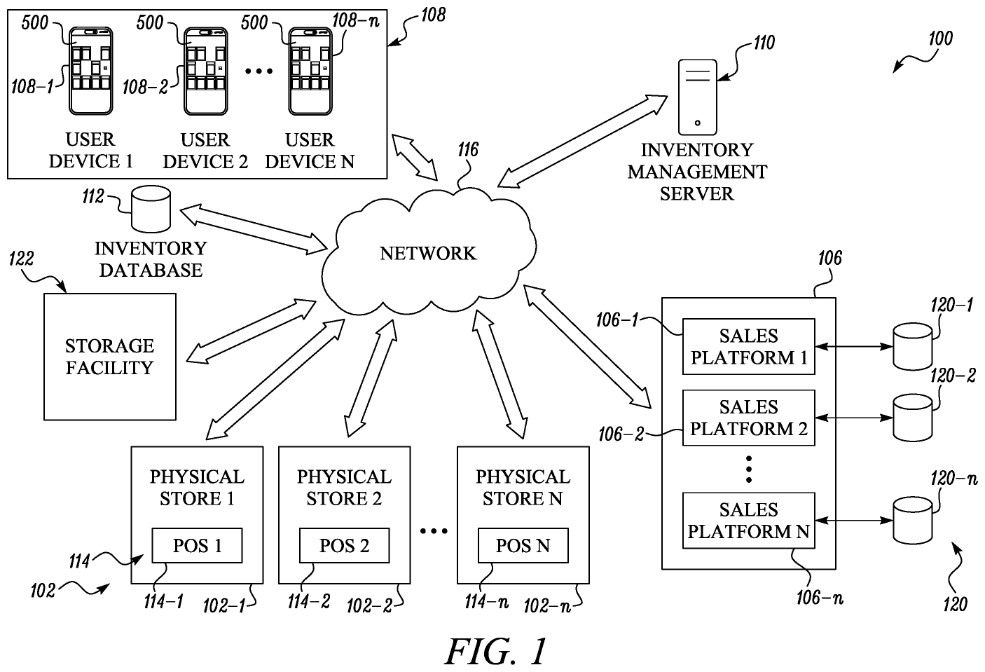

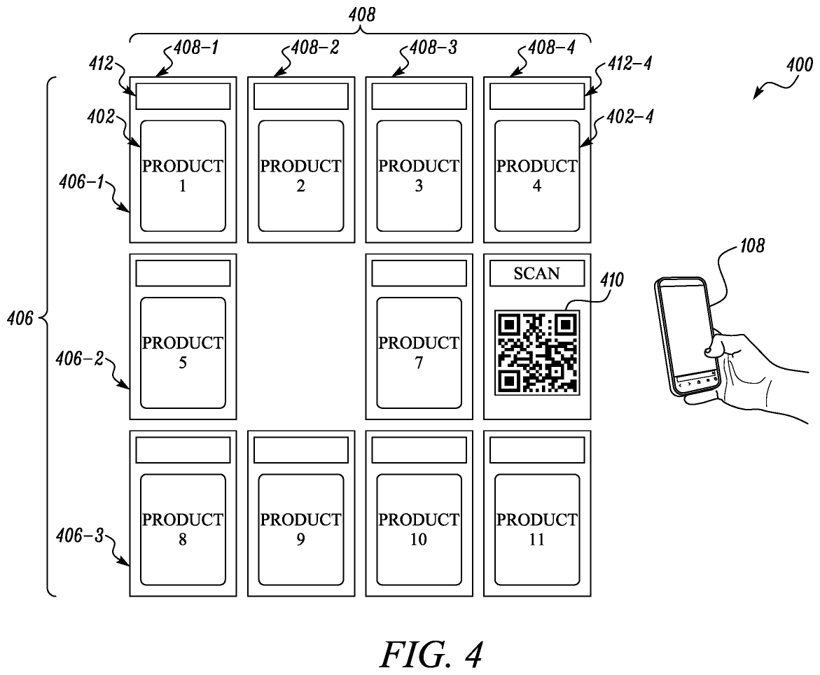

FIG. 1 is a block diagram of a system 100 for inventory management of a one-of-a-kind product (interchangeably referred to as a product). The product includes, but is not limited to, a trading card, a mint card, a coin, a stamp, or any article that can be offered for sale now known or in the future developed. In accordance with various embodiments, the product is a unique product with a single quantity. For example, the product is a collectible graded card, such as a baseball, a basketball, or a football card. The product is identified by a product identifier that is unique to the product. The product is further associated with corresponding product information including, but not limited to, a trading status, a physical location, and one or more attributes of the product. The trading status represents whether the product is available for sale or not. For example, when the product is unsold, the trading status represents that the product is available for sale and when the product is sold, the trading status is updated to represent that the product is not available for sale. The physical location of the product includes coordinates or position data corresponding to a physical slot (described later with reference to FIG. 4) at which the product is stored or displayed. The attributes of the product include an image, one or more grading details, one or more pricing details, and other data associated with the product. Although the product is described as a one-of-a-kind product with a single quantity, a person skilled in the art would appreciate that the product can be any product without any limitation on the number of units associated with the product.

The system 100 includes one or more physical stores 102 (such as, but not limited to 102-1, 102-2, . . . 102-n), one or more online sales platforms 106 (for example, but not limited to, online sales platforms 106-1, 106-2, . . . 106-n), one or more user devices 108 (such as, but not limited, to 108-1, 108-2, . . . 108-n), an inventory management server 110, an inventory database 112, and a storage facility 122. In some embodiments, communication between the one or more physical stores 102 (via respective Point of Sale (POS) systems 114), the one or more online sales platforms 106, the one or more user devices 108, the inventory management server 110, and the inventory database 112 occurs through a network 116. In some embodiments, the network 116 includes one or more networks such that the network used for communication between the POS systems 114 and the inventory management server 110 is different from the network used for communication between the user devices 108 and the inventory management server 110. The network 116 includes, for example, a wide area network (WAN) (for example, a transport control protocol/internet protocol (TCP/IP) based network), a cellular network, a local area network (LAN), or a combination thereof employing one or more of a variety of communications protocols as is well known in the art or developed in the future.

The one or more physical stores 102 are “brick and mortar” stores that offer the product for sale in a physical retail environment. Each physical store 102 is either a merchant store or a franchise store. In accordance with various embodiments, when the product is a single quantity product, the product is physically stored or displayed at any one of the physical stores 102 while the remaining physical stores 102 offer the product for sale without storing or displaying the product. In an exemplary embodiment, the product is stored or displayed at the physical store 102-1 for sale while the remaining physical stores 102-2 . . . 102-n offer the product for sale without storing or displaying the product.

Each physical store 102 includes a grid 400 (shown in FIG. 4) for displaying a plurality of products offered for sale. As shown in FIG. 4, the grid 400 includes multiple physical slots 402 dispersed across the grid 400. Each physical slot 402 is used to display a product of the plurality of products. The remaining attributes, such as, the pricing details and the grading details, of the product are also displayed, for example, in a portion 412 of the physical slot 402 of the grid 400. The grid 400 includes one or more rows 406 (such as, but not limited to, 406-1, 406-2, 406-3) and one or more columns 408 (such as, but not limited to, 408-1, 408-2, 408-3, 408-4) extending perpendicular to the rows 406. Although not shown, each row 406 is identified by a unique row identifier and each column 408 is identified by a unique column identifier. The row identifier and the column identifier include one or more of an alphabet, a numeric value, and/or a special character. In so doing, the position data of each physical slot 402 is identified (e.g., uniquely identified) by a concatenation of a corresponding column identifier and a corresponding row identifier.

For ease of reference, the grid 400 shown in FIG. 4 is assumed to be associated with the physical store 102-1 that stores/displays the product offered for sale. As shown in FIG. 4, the product offered for sale, for example, ‘PRODUCT 4’, is inserted in a physical slot 402-4 of the multiple physical slots 402 in the grid 400 of the physical store 102-1 for display. Further, the remaining attributes are displayed in a portion 412-4 of the physical slot 402-4 of the grid 400 of the physical store 102-1. In such a scenario, the physical location of the product (‘PRODUCT 4’) includes, but is not limited to, the position data of the physical slot 402-4 in the grid 400 of the physical store 102-1. Although the remaining physical stores 102-2, . . . 102-n are described as not displaying/storing the ‘PRODUCT 4’ for sale in their respective grids, it would be appreciated that the grids in the remaining physical stores 102-2, . . . 102-n are used to store/display other such products offered for sale.

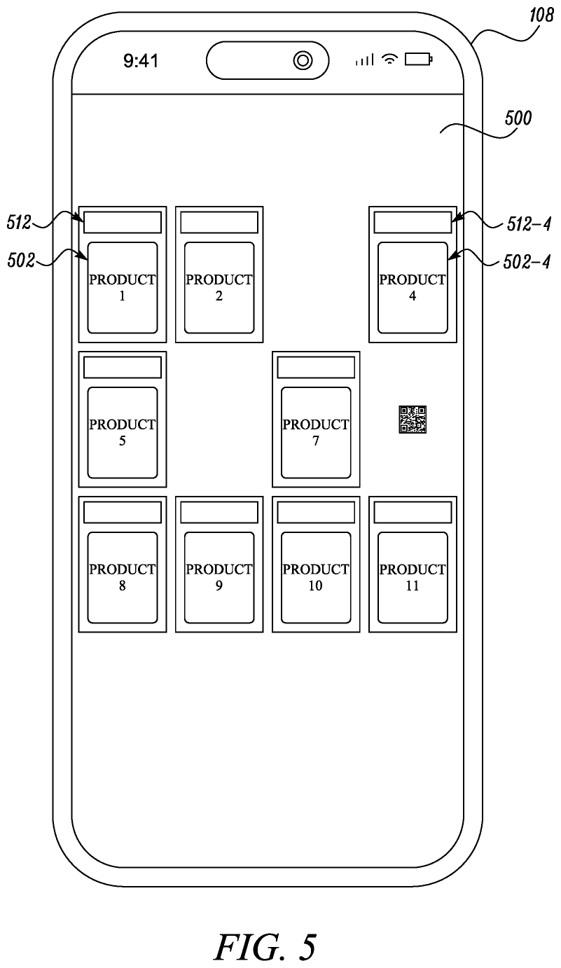

In some embodiments, each grid 400 also includes a unique webpage identifier 410 corresponding to a webpage including a graphical representation 500 (shown in FIG. 5) of the corresponding grid 400. Although the identifier in the grid 400 is described as the webpage identifier 410, a person skilled in the art would appreciate that the identifier can be any identifier, such as, a mobile application identifier, corresponding to a mobile application including the graphical representation 500 of the corresponding grid 400. As shown in FIG. 5, the graphical representation 500 of each grid 400 includes a plurality of virtual slots 502 corresponding to the multiple physical slots 402 in the corresponding grid 400. Each virtual slot 502 is used to display an image and other attributes of a product of the plurality of products. In the exemplary embodiment discussed above, the image and the remaining attributes of the product (‘PRODUCT 4’) are displayed in a virtual slot 502-4 corresponding to the physical slot 402-4 of the grid 400 of the physical store 102-1. As shown, the remaining attributes of the product (‘PRODUCT 4’) are displayed in a portion 512-4 of the virtual slot 502-4 of the grid 400 of the physical store 102-1. In accordance with various embodiments, for each grid 400, the positioning of each of the plurality of virtual slots 502 in the corresponding graphical representation 500 of the webpage or the mobile application corresponds to an actual positioning of the corresponding multiple physical slots 402 in the corresponding grid 400. For example, as shown in FIGS. 4 and 5, the positioning of the virtual slot 502-4 in the graphical representation 500 corresponds to the actual positioning of the corresponding physical slot 402-4 in the corresponding grid 400 of the physical store 102-1. Although not shown, in some embodiments, the positioning of each of the plurality of virtual slots 502 in the graphical representation 500 differs from the actual positioning of the corresponding multiple physical slots 402 in the corresponding grid 400 of the physical store 102-1.

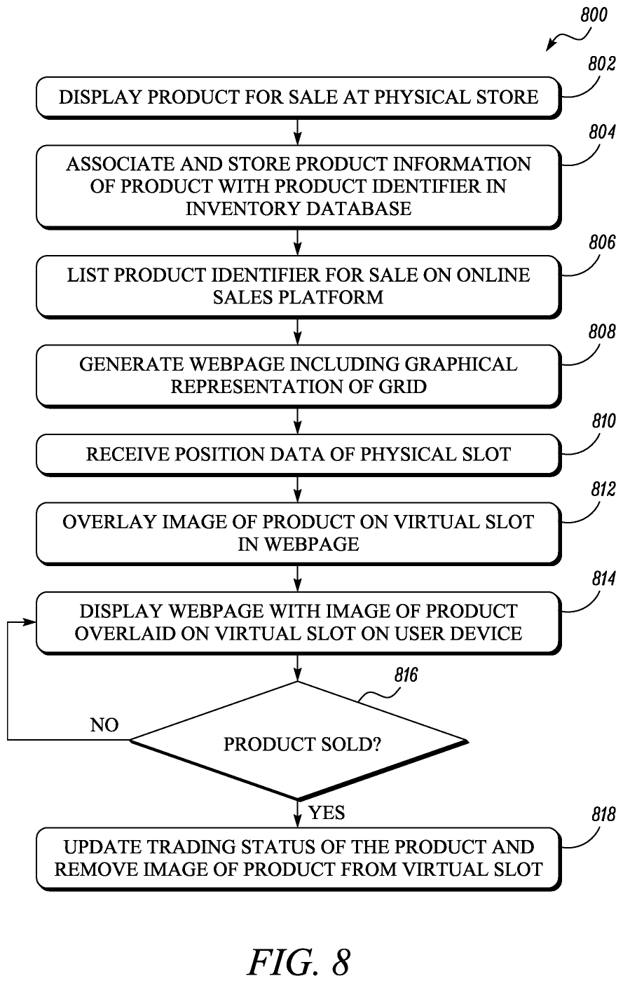

Referring back to FIG. 4, in accordance with various embodiments, the webpage identifier 410 displayed in the grid 400, for example, of the physical store 102-1, enables one or more customers of the physical store 102-1 to view (via respective user devices 108) the one or more attributes corresponding to the plurality of products displayed in the grid 400 of the physical store 102-1, as will be described in detail later with reference to FIGS. 5 and 8. Although the webpage identifier 410 is shown as displayed in the grid 400, a person skilled in the art would appreciate that the webpage identifier 410 can be displayed at any location in the physical store 102-1 to access the graphical representation 500 (shown in FIG. 5) corresponding to the grid 400 of the physical store 102-1. In some embodiments, the remaining physical stores 102-2, . . . 102-n also display the webpage identifier 410 of the grid 400 of the physical store 102-1 to enable the customer to view and purchase the products displayed for sale in the grid 400 of the physical store 102-1. The webpage identifier 410 includes one or more of a Quick Response (QR) code, a Uniform Resource Locator (URL) link associated with the webpage, a Near Field Communication (NFC) tag, or any identifier, now known in the art or developed in future. The details and functionality related to the graphical representation 500 will be described later with reference to FIG. 5.

Referring back to FIG. 1, each physical store 102 is associated with the respective POS systems 114. Each POS system 114 includes a list of product identifiers associated with the plurality of products available for sale along with the product information, such as, the trading status of each product. For example, the POS system 114-1 includes the list of product identifiers associated with the products available for sale at the corresponding physical store 102-1 as well as other physical stores 102-2, . . . 102-n. Each POS system 114 is configured to record transactions associated with the sale of a product and notify the inventory management server 110 when the product is sold in the corresponding physical store 102. For example, the POS system 114-1 is configured to record transactions associated with the sale of the ‘PRODUCT 4’ and notify the inventory management server 110 when the ‘PRODUCT 4’ is sold in the corresponding physical store 102-1. To this end, each POS system 114 is configured to determine the product identifier associated with the product by, for example, scanning a tag (including the product identifier) associated with the product and transmit a notification to the inventory management server 110 to update the trading status of the product associated with the product identifier when the product is sold at the corresponding physical store 102. In accordance with various embodiments, updating the trading status of the product corresponds to marking the product as sold or not available for sale. In some embodiments, each POS system 114 is configured to receive a notification to update the trading status of the product associated with the product identifier from the inventory management server 110 when the product associated with the product identifier is sold at one of the other sales platforms, such as, the remaining physical stores 102 or the one or more online sales platforms 106. In such cases, the POS system 114 is configured to update the trading status of the product and deny the sale of the product upon updating the trading status of the product.

In accordance with various embodiments, the one or more online sales platforms 106 are configured to list the product identifier associated with the product for sale on their respective websites and/or applications. The one or more online sales platforms 106 are e-commerce sites that allow the inventory management server 110 of a merchant to list the product identifier associated with the product offered for sale on their respective websites and/or applications. For example, the one or more online sales platforms 106 include Amazon®, Alibaba®, EBay®, Etsy®, Google Express®, Walmart®, and any other online sales platform known in the art or developed in the future. Each of the one or more online sales platforms 106 is configured to receive the product identifier and the product information associated with the product identifier of the product from the inventory management server 110 and create an entry including the product identifier and the product information in its corresponding database 120 (such as, but not limited to, 120-1, 120-2 . . . 120-n). The product information along with the product identifier is then listed on the one or more online sales platforms 106 for sale. Each of the one or more online sales platforms 106 is then configured to notify the inventory management server 110 when the product corresponding to the product identifier is sold on the respective online sales platform 106. In some embodiments, each of the one or more online sales platforms 106 is configured to receive a notification from the inventory management server 110 to update the trading status of the product associated with the product identifier in the databases 120 and delete the listing of the product identifier from their respective websites and/or applications when the product is sold in one of the other sales platforms, such as, the physical stores 102 or the remaining one or more online sales platforms 106.

In some embodiments, each of the one or more online sales platforms 106 is configured to assign a new identifier to the product and map the new identifier to the product identifier provided by the inventory management server 110. Each of the one or more online sales platforms 106 is then configured to store the mapping in the respective databases 120. In such cases, when the product is sold on the online sales platform 106, for example, the online sales platform 106-1, the online sales platform 106-1 is configured to identify the new identifier associated with the product that is sold, determine the product identifier corresponding to the new identifier from the database 120-1, and provide the product identifier to the inventory management server 110 to notify the inventory management server 110 of the sale of the product. Similarly, when the online sales platform 106-1 receives the notification from the inventory management server 110 to update the trading status of the product associated with the product identifier and delete the listing of the product identifier from the website and/or application, the online sales platform 106-1 is configured to identify the new identifier corresponding to the product identifier based on the mapping stored in the database 120-1 and update the trading status of the product corresponding to the new identifier and remove the listing of the product identifier corresponding to the new identifier.

In accordance with various embodiments, the inventory database 112 is configured to associate and store the product information with the product identifier of the product that is up for sale at the physical stores 102 and/or on the one or more online sales platforms 106. In some embodiments, the inventory database 112 is managed by the inventory management server 110. For example, the inventory database 112 is configured to receive the product information along with the product identifier, associated with the product via the inventory management server 110 from the merchant, and generate an entry, via the inventory management server 110, for the product by associating the product identifier with the product information for storage. Although not shown, in some embodiments, the inventory database 112 is a part of the inventory management server 110.

In accordance with various embodiments, the system 100 also includes the storage facility 122 for storing the plurality of products. In an exemplary embodiment, the product offered for sale, for example, the ‘PRODUCT 4’, is stored in the storage facility 122 and the physical stores 102 offer the product for sale without storing or displaying the product. In some embodiments, the storage facility 122 also includes a storage arrangement including a plurality of storage compartments to store the products. In such cases, the physical location of a product corresponds to a position data of a storage compartment in which the product is stored at the storage facility 122.

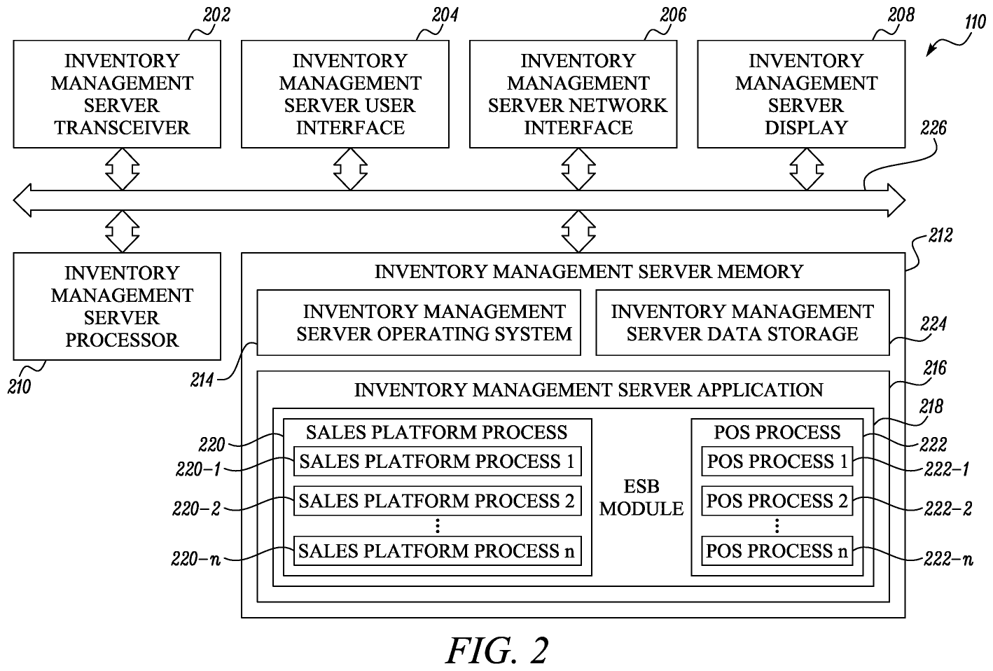

In accordance with various embodiments, the inventory management server 110 is configured to display the graphical representation 500 (shown in FIG. 5) on the one or more user devices 108 and send a request to update the trading status of the product in the databases 120, the POS systems 114, and the inventory database 112 when the product is sold. For ease of reference, the components and the functionality of the inventory management server 110 are described in detail hereinafter with reference to FIG. 2.

In accordance with various embodiments, each of the one or more user devices 108 operates as a user interface for one or more users, such as one or more customers, for viewing the graphical representations 500 (shown in FIG. 5) of the grids 400 (shown in FIG. 4) of the physical stores 102 and for receiving inputs for interfacing with the websites and/or applications of the one or more online sales platforms 106 including purchasing the product from one of the one or more online sales platforms 106. As shown in FIG. 4, the user device 108 is configured to access/scan the webpage identifier 410 displayed in the physical store 102, for example, the physical store 102-1, to transmit a request to the inventory management server 110 to access the graphical representation 500 (shown in FIG. 5) of the grid 400 of the physical store 102-1. As shown in FIG. 5, the user device 108 is then configured to display the graphical representation 500 corresponding to the grid 400 (shown in FIG. 4) upon receiving a response from the inventory management server 110. The graphical representation 500 includes the plurality of virtual slots 502 corresponding to the multiple physical slots 402 in the grid 400 of the physical store 102-1.

FIG. 2 is a block diagram of one exemplary embodiment of the inventory management server 110 for use within the system 100 of FIG. 1. The inventory management server 110 is electrically and/or communicatively coupled to the POS systems 114 of the physical stores 102, the one or more user devices 108, the one or more online sales platforms 106, and the inventory database 112. In some embodiments, the inventory management server 110 includes a plurality of electrical and electronic components, for example for providing power, operational control, and communication within the inventory management server 110. For example, in one embodiment, the inventory management server 110 includes, among other things, an inventory management server transceiver 202, an inventory management server user interface 204, an inventory management server network interface 206, an inventory management server display 208, an inventory management server processor 210, and an inventory management server memory 212.

It should be appreciated by those of ordinary skill in the art that FIG. 2 depicts the inventory management server 110 in a simplified manner and a practical embodiment includes additional components and suitably configured logic to support known or conventional operating features that are not described in detail herein. It will further be appreciated by those of ordinary skill in the art that the inventory management server 110 is a personal computer, a desktop computer, a tablet, a smartphone, a wearable device, or any other device operating as a server now known or in the future developed. It will further be appreciated by those of ordinary skill in the art that the inventory management server 110 alternatively functions within a remote server, a cloud server, or any other remote computing mechanism now known or in the future developed. In some embodiments, the functionality of the inventory management server 110 is performed in a single device. Alternatively, in some other embodiments, the functionality of the inventory management server 110 is distributed among multiple devices.

The components of the inventory management server 110 (for example 202, 204, 206, 208, 210, and 212) are communicatively coupled via a server local interface 226. The server local interface 226 includes, for example, but not limited to, one or more buses or other wired or wireless connections, as is known in the art. In an embodiment, the server local interface 226 has additional elements, which are omitted for simplicity, such as controllers, buffers (caches), drivers, repeaters, and receivers, among many others, to enable communications. Further, in some embodiments, the server local interface 226 includes address, control, and/or data connections to enable appropriate communications among the aforementioned components.

The inventory management server 110 in the illustrated example includes the inventory management server transceiver 202. The inventory management server transceiver 202 incorporating within an inventory management server transceiver antenna (not shown), enables wireless communication between the inventory management server 110 and other devices, for example, the one or more online sales platforms 106, the POS systems 114 of the physical stores 102, the one or more user devices 108, and the inventory database 112. It will be appreciated by those of ordinary skill in the art that the inventory management server 110 includes a single inventory management server transceiver 202 as shown, or alternatively separate transmitting and receiving components, for example, but not limited to, a transmitter, a transmitting antenna, a receiver, and a receiving antenna and/or any combination thereof.

The inventory management server user interface 204 is used to receive input from and/or provide output to one or more users, such as, the merchant. The input is provided via, for example, a keyboard, touchpad, a mouse, and/or any other user input now known or in the future developed, or any combination thereof. The output is provided via the inventory management server display 208, speakers, a printer (not shown) and/or any other system output now known or in the future developed, or any combination thereof. The inventory management server user interface 204 further includes, for example, a serial port, a parallel port, an infrared (IR) interface, a universal serial bus (USB) interface, and/or any other interface now known or in the future developed.

The inventory management server network interface 206 is used to enable the inventory management server 110 to communicate on one or more networks, such as, the network 116 of FIG. 1. The inventory management server network interface 206 includes, for example, one or more of an Ethernet card or adapter or a wireless local area network (WLAN) card or adapter. Additionally, or alternatively, the inventory management server network interface 206 includes one or more of a radio frequency interface for wide area communications such as Long-Term Evolution (LTE) networks, or any other network now known or in the future developed. In an embodiment, the inventory management server network interface 206 includes address, control, and/or data connections to enable appropriate communications on the network. The inventory management server display 208 includes a display screen or a computer monitor now known or in the future developed. In accordance with some embodiments, the inventory management server display 208 is configured to display any data, such as, but not limited to, the product information, the product identifier, the graphical representation 500 (shown in FIG. 5), and the webpage identifier 410 (shown in FIG. 4).

The inventory management server memory 212 includes any non-transitory memory elements comprising one or more of volatile memory elements (for example, random access memory (RAM), nonvolatile memory elements (for example, read-only memory “ROM”), and combinations thereof). Moreover, the inventory management server memory 212 incorporates electronic, magnetic, optical, and/or other types of storage media now known or in the future developed. Note that, in some embodiments, the inventory management server memory 212 has a distributed architecture, where various components are situated remotely from one another, but are accessed by the inventory management server processor 210. The software in the inventory management server memory 212 includes one or more software programs, each of which includes an ordered listing of executable instructions for implementing logical functions. The software in the inventory management server memory 212 includes an inventory management server operating system 214 and one or more inventory management server applications 216. The inventory management server operating system 214 controls the execution of other computer programs, such as, the one or more inventory management server applications 216, and provides scheduling, input-output control, file and data management, memory management, and communication control and related services.

The one or more inventory management server applications 216 include an Enterprise Service Bus (ESB) module 218. The ESB module 218 provides integration capabilities by performing routing of messages between the inventory management server 110 and other devices, such as, the one or more online sales platforms 106, the POS systems 114, the inventory database 112, and the inventory management server 110 over the one or more networks, such as the network 116. In some embodiments, the ESB module 218 also the converts communication/notifications received from and transmitted to the one or more online sales platforms 106, the POS systems 114, and the inventory database 112 as the one or more online sales platforms 106, the POS systems 114, and the inventory database 112 may utilize different messaging formats and communication protocols from the inventory management server 110. The ESB module 218 includes one or more online sales platform processes 220 and one or more POS processes 222. Each online sales platform process 220 of the one or more online sales platform process 220 is associated with a unique online sales platform 106 of the one or more online sales platforms 106 for handling communications corresponding to the sale of the product associated with the product identifier on the corresponding online sales platform 106. For example, as shown in FIG. 5, the online sales platform process 220-1 is associated with the online sales platform 106-1. Each POS process 222 of the one or more POS processes 222 is associated with a unique POS system 114 for handling communications corresponding to the sale of the product associated with the product identifier in the corresponding physical store 102. For example, as shown in FIG. 5, the POS process 222-1 is associated with the POS system 114-1 of the physical store 102-1.

The inventory management server memory 212 further includes an inventory management server data storage 224 used to store data. In the exemplary embodiment of FIG. 2, the inventory management server data storage 224 is located internal to the inventory management server memory 212 of the inventory management server 110. Additionally, or alternatively (not shown), the inventory management server data storage 224 is located external to the inventory management server 110 such as, for example, an external hard drive connected to the inventory management server user interface 204. In some embodiments (not shown), the inventory management server data storage 224 is located externally and connected to the inventory management server 110 through a network and accessed via the inventory management server network interface 206. In some embodiments, the externally located inventory management server data storage 224 corresponds to the inventory database 112 which stores the product information and the product identifier associated with the product. Alternatively, in other embodiments, the inventory management server data storage 224 and the inventory database 112 are distinct storage units. In operation, information for storage in the inventory management server data storage 224 is entered via the inventory management server user interface 204.

The inventory management server processor 210 is a hardware device for executing software instructions and the one or more inventory management server applications 216, such as, the ESB module 218. In an embodiment, the inventory management server processor 210 is any custom-made or commercially available processor, a central processing unit (CPU), an auxiliary processor among several processors associated with the inventory management server processor 210, a semiconductor-based microprocessor, or generally any device for executing software instructions now known or in the future developed. When the inventory management server 110 is in operation, the inventory management server processor 210 is configured to execute software stored within the inventory management server memory 212, to communicate data to and from the inventory management server memory 212, and to generally control operations of the inventory management server 110 pursuant to the software instructions.

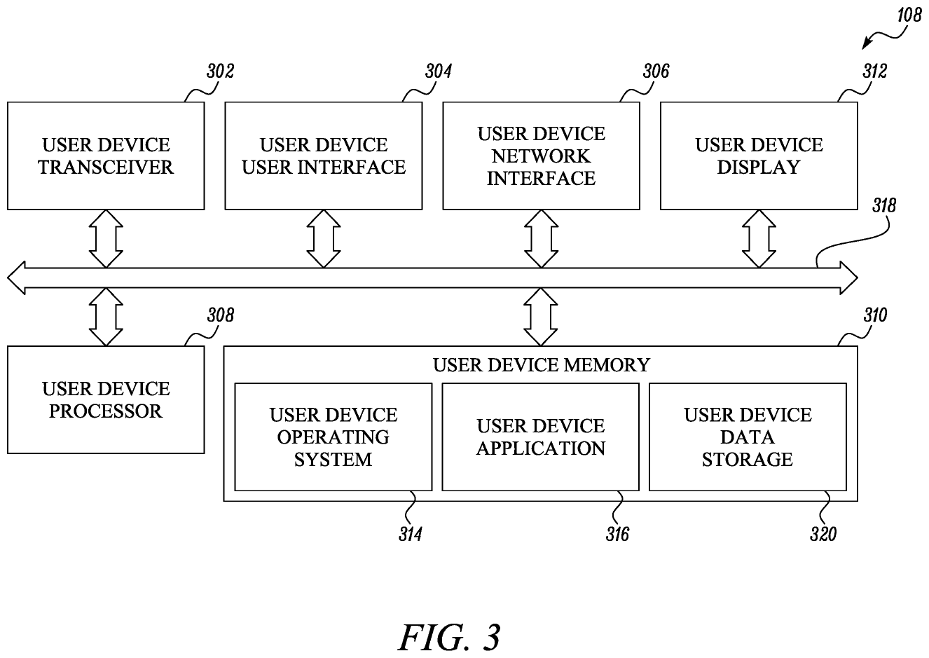

FIG. 3 is a block diagram of one exemplary embodiment of the user device 108 for use within the system 100 of FIG. 1. For ease of reference, the components, and the functionality of one user device 108 are described hereinafter, however each of the same components and functionality are applicable to other user devices 108 shown in FIG. 1. In accordance with some embodiments, the user device 108 is a tablet, a smartphone, or any other computer or user device now known or in the future developed. In some embodiments, the user device 108 is electrically and/or communicatively coupled to a variety of other devices, for example, the inventory management server 110. The user device 108 includes a number of electrical and electronic components, providing power, operational control, communication within the user device 108. For example, the user device 108 in one embodiment includes, among other elements, a user device transceiver 302, a user device user interface 304, a user device network interface 306, a user device processor 308, a user device memory 310, and a user device display 312.

The components of the user device 108 (for example 302, 304, 306, 308, 310, 312) are communicatively coupled via a user device local interface 318. The user device local interface 318 includes, for example, but is not limited to, one or more buses or other wired or wireless connections, as is known in the art. In an embodiment, the user device local interface 318 has additional elements, which are omitted for simplicity, such as controllers, buffers (caches), drivers, repeaters, and receivers, among many others, to enable communications. Further, in some embodiments, the user device local interface 318 includes address, control, and/or data connections to enable appropriate communications among the aforementioned components.

The user device 108 includes the user device transceiver 302. The user device transceiver 302 incorporated within a user device transceiver antenna (not shown), enables wireless communication between the devices, for example, the inventory management server 110 of FIG. 1. It will be appreciated by those of ordinary skill in the art that the user device 108 includes a single user device transceiver 302 as shown, or alternatively separate transmitting and receiving components, for example but not limited to, a transmitter, a transmitting antenna, a receiver, and a receiving antenna and/or any combination thereof

The user device user interface 304 is used to receive input from the inventory management server 110, the one or more online sales platforms 106, and/or the user, for example, the customer to interface with the graphical representations 500 and the one or more online sales platforms 106. The user device user interface 304 is also used to provide system output to the user (for example, the customer) or to one or more devices. The user device user interface 304 includes one or more input devices, including but not limited to a camera, a scanner, a navigation key, a function key, a microphone, a voice recognition component, a joystick, or any other mechanism capable of receiving an input (for example, a webpage identifier 410 and/or a selection of a virtual slot 502 of the graphical representation 500) from the user now known or in the future developed, or any combination thereof. Further, the user device user interface 304 includes one or more output devices, including but not limited to a speaker, headphones, a display, or any other mechanism capable of presenting an output (for example, the graphical representation 500) to a user now known or in the future developed, or any combination thereof. In some embodiments, the user device user interface 304 includes a user interface mechanism, such as a touch interface or gesture detection mechanism that allows a user to interact with the displayed output. As illustrated, the user device display 312 is a separate user interface or combined within the user device user interface 304. In some embodiments, the user device display 312 is configured to display the graphical representation 500.

The user device network interface 306 is used to enable the user device 108 to communicate on a network, such as, the network 116 of FIG. 1. In an embodiment, the user device network interface 306 includes, for example, an Ethernet card or adapter or a wireless local area network (WLAN) card or adapter. Additionally, or alternatively, the user device network interface 306 includes a radio frequency interface for wide area communications such as Long-Term Evolution (LTE) networks, or any other network now known or in the future developed. In some embodiments, the user device network interface 306 includes address, control, and/or data connections to enable appropriate communications on the network.

The user device memory 310 includes any non-transitory memory elements comprising one or more of volatile memory elements (for example, random access memory (RAM), nonvolatile memory elements (for example, read-only memory “ROM”), and combinations thereof). Moreover, in some embodiments, the user device memory 310 incorporates electronic, magnetic, optical, and/or other types of storage media now known or in the future developed. Note that, in an embodiment, the user device memory 310 has a distributed architecture, where various components are situated remotely from one another but are accessed by the user device processor 308. The software in the user device memory 310 includes one or more software programs, each of which includes an ordered listing of executable instructions for implementing logical functions. The software in the user device memory 310 includes a suitable user device operating system 314 and one or more user device applications 316. The user device operating system 314 controls the execution of other computer programs, such as, the one or more user device applications 316, and provides scheduling, input-output control, file and data management, memory management, and communication control and related services. The one or more user device applications 316 are configured to implement the various processes, algorithms, methods, techniques described herein. The user device memory 310 further includes a user device data storage 320 used to store data.

The user device processor 308 is a hardware device for executing software instructions now known or in the future developed. In an embodiment, the user device processor 308 is any custom-made or commercially available processor, a central processing unit (CPU), an auxiliary processor among several processors associated with the user device processor 308, a semiconductor-based microprocessor, or generally any device for executing software instructions. When the user device 108 is in operation, the user device processor 308 is configured to execute software stored within the user device memory 310, to communicate data to and from the user device memory 310, and to generally control operations of the user device 108 pursuant to the software instructions.

FIG. 8 illustrates the method 800 for the inventory management of the product across the physical stores 102 and the one or more online sales platforms 106. The method begins at 802 with displaying the product for sale at a physical store 102, for example, the physical store 102-1. As shown in FIG. 4, the product, for example, ‘PRODUCT 4’, is inserted in the physical slot 402-4 of the multiple physical slots 402 in the grid 400 of the physical store 102-1 for display. In some embodiments, the other attributes of the product are also displayed in the portion 412-4 of the physical slots 402-4 of the grid 400 of the physical store 102-1.

Referring back to FIG. 8, at 804, the inventory management server processor 210 associates and stores the product information of the product with the product identifier in the inventory database 112. To this end, the inventory management server processor 210 receives inputs such as, the product identifier associated with the product from the merchant via the inventory management server user interface 204 and generates the entry for the product based on the product identifier in the inventory database 112. The inventory management server processor 210 receives inputs such as, the product information, from the merchant via the inventory management server user interface 204, associates the product information with the product identifier, and stores the association in the inventory database 112.

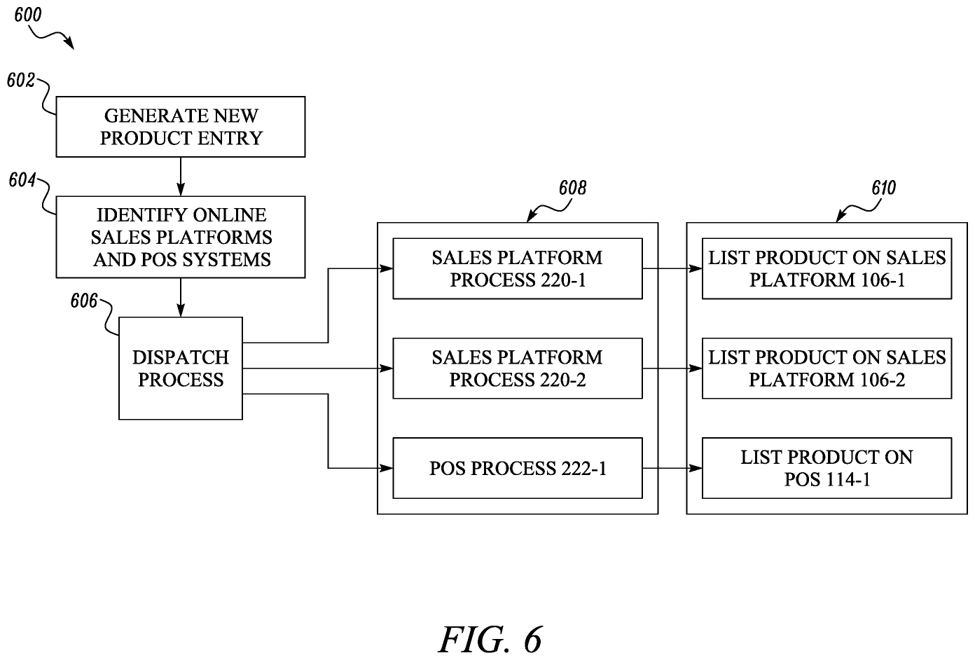

At 806, the inventory management server processor 210 provides instructions to the one or more online sales platforms 106 and the POS systems 114 to list the product identifier associated with the product on the respective one or more online sales platforms 106 and the POS systems 114, as described in FIG. 6. In an exemplary process flow 600 shown in FIG. 6, upon generation of the entry for the product in the inventory database 112 at 602, the inventory management server processor 210 receives inputs such as, identification of one or more of online sales platforms 106 and identification of one or more of the POS systems 114 on which the merchant wishes to list the product for sale, from the merchant via the inventory management server user interface 204, at 604. For example, as shown in FIG. 6, the merchant identifies the online sales platforms 106-1, 106-2, and the POS system 114-1 for listing the product identifier associated with the product for sale. The inventory management server processor 210 associates the identification of the online sales platforms 106-1 and 106-2 and the identification of the POS system 114-1 with the product identifier and store the association in the inventory database 112.

At 606, the inventory management server processor 210 executes the ESB module 218 to run a dispatch process to dispatch a message including the product identifier and the product information to the identified one or more online sales platforms 106 (for example, the online sales platforms 106-1, 106-2) and the identified POS system 114 (for example, the POS system 114-1). At 608, the inventory management server processor 210 executes the ESB module 218 to run the one or more online sales platform processes 220 (for example, the online sales platform processes 220-1, 220-2) associated with the identified one or more online sales platforms 106-1 and 106-2 and the one or more POS processes 222 (for example, the POS process 222-1) associated with the identified POS system 114-1 to convert the message into a messaging format and a communication protocol corresponding to each of the identified one or more online sales platform 106-1 and 106-2 and the identified POS system 114-1, respectively. At 610, the inventory management server processor 210 provides the respective converted messages to the identified one or more online sales platforms 106-1 and 106-2 and the identified POS system 114-1 to list the product on their respective platforms.

Referring back to FIG. 8, at 808, the inventory management server processor 210 generates the webpage or the mobile application interface having the graphical representation 500 (shown in FIG. 5) of the grid 400 (shown in FIG. 4) of the physical store 102, for example, the physical store 102-1. To this end, the inventory management server processor 210 receives from the merchant via the inventory management server user interface 204, inputs associated with the actual positioning (for example, the position data) of the multiple physical slots 402 in the grid 400 (shown in FIG. 4) of the physical store 102-1. The inventory management server processor 210 then creates the graphical representation 500 (shown in FIG. 5) including the virtual slots 502 corresponding to the actual positioning of the corresponding multiple physical slots 402 in the grid 400. Although not shown, in some embodiments, the positioning of each of the plurality of virtual slots 502 in the graphical representation 500 differs from the actual positioning of the corresponding multiple physical slots 402 in the grid 400, depending upon the requirement of the merchant.

At 810, the inventory management server processor 210 receives the position data of the physical slot (for example, the physical slot 402-4) having the product (‘PRODUCT 4’) from the inventory database 112 and overlays the image of the product on the virtual slot 502-4 corresponding to the physical slot 402-4, at 812. At 814, upon receiving a request from a user device 108, the inventory management server processor 210 instructs the user device processor 308 to control the user device user interface 304 of the user device 108 to display the graphical representation 500 with the image of the product (‘PRODUCT 4’) overlaid on the virtual slot 502-4 of the graphical representation 500 (shown in FIG. 5). To this end, when the user device 108 accesses/scans the webpage identifier 410 (shown in FIG. 4) displayed in any of the physical stores 102, the request to access the graphical representation 500 (shown in FIG. 5) is received by the inventory management server transceiver 202. The inventory management server 110, upon receiving the request, displays the graphical representation 500 with the image of the product (‘PRODUCT 4’) overlaid on the virtual slot 502-4 of the graphical representation 500 (shown in FIG. 5) on the user device user interface 304 of the user device 108.

At 816, the inventory management server processor 210 determines whether the product is sold at any one of the sales platforms, such as the one or more online sales platforms 106 and the one or more of the POS systems 114. At 818, the inventory management server processor 210 updates the trading status of the product associated with the product identifier on the one or more online sales platforms 106, the POS systems 114, and the inventory database 112 when the product is sold in any one of these sales platforms, such as, the one or more online sales platforms 106 and the POS systems 114. For example, when the product is sold by an online sales platform 106-1 of the one or more online sales platforms 106, the ESB module 218 receives data corresponding to the sale of the product associated with the product identifier from the online sales platform 106-1 and analyzes the received data based on the online sales platform process 220-1 corresponding to the online sales platform 106-1. The ESB module 218 then updates the trading status of the product associated with the product identifier across the remaining online sales platforms 106 (for example, the online sales platform 106-2), the POS systems 114, and the inventory database 112 based on the analyzed data corresponding to the sale of the product. The ESB module 218 repeats the same process when the product is sold on one of the POS systems 114. In such cases, when the product is sold, the one or more user devices 108 upon sending the request to the inventory management server 110 receives the graphical representation 500 having the image of the ‘PRODUCT 4’ removed from the virtual slot 502-4 of the graphical representation 500. When the product is not sold at 816, the inventory management server processor 210 continues to display the graphical representation 500 with the image of the product (‘PRODUCT 4’) overlaid on the virtual slot 502-4 of the graphical representation 500 (shown in FIG. 5) on the one or more user devices 108.

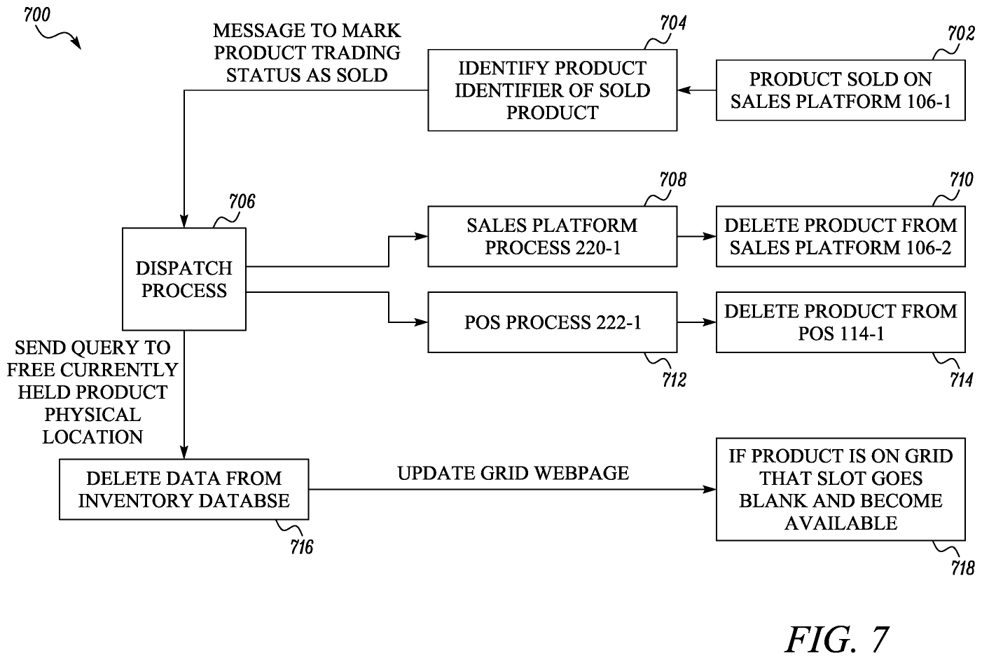

In an exemplary process flow 700 shown in FIG. 7, when the product is sold on the online sales platform 106-1 at 702, the online sales platform 106-1 identifies the product identifier, for example, based on the mapping stored in the database 120-1, at 704. For example, in some embodiments, when the online sales platform 106-1 utilizes the new identifier to list the product on its website and/or application, the online sales platform 106-1 identifies the product identifier corresponding to the new identifier based on the mapping stored in the database 120-1. The online sales platform 106-1 transmits a message including the product identifier of the sold product to the inventory management server 110. In some embodiments, the online sales platform 106-1 provides the message including the product identifier of the sold product to the inventory management server 110 based on a messaging format and a communication protocol employed by the inventory management server 110. In some alternate embodiments, the inventory management server 110 converts the message including the product identifier of the sold product received from the online sales platform 106-1 based on the messaging format and the communication protocol employed by the inventory management server 110. At 706, upon receiving the product identifier of the sold product, the inventory management server processor 210 executes the ESB module 218 to dispatch a message to the other sales platform, such as, the remaining online sales platforms 106 (for example, the online sales platform 106-2) and the POS systems 114 (for example, the POS system 114-1) to update the trading status of the product and delete the listing of the product identifier of the product from their respective sales platforms.

At 708, the inventory management server processor 210 executes the ESB module 218 to run the one or more online sales platform processes 220 (for example, the online sales platform process 220-2) associated with the online sales platform 106-2 to convert the message into the messaging format and the communication protocol corresponding to the online sales platform 106-2. At 710, upon receiving the message, the online sales platform 106-2 deletes the listing of the product identifier from its website and/or application and updates the trading status of the product. At 712, the inventory management server processor 210 executes the ESB module 218 to run the one or more POS processes 222 (for example, the POS process 222-1) to convert the message into the messaging format and the communication protocol corresponding to the POS system 114-1. At 714, upon receiving the message, the POS system 114-1 deletes the listing of the product identifier from its system and updates the trading status of the product. Once the trading status of the product is updated, the POS system 114-1 will deny any further sale of the product at the corresponding physical store 102-1. Although FIG. 7 describes the process for updating the trading status of the product when the product is sold on the online sales platform 106-1, a person skilled in the art would appreciate that a similar process will be followed when the product is sold at one of the POS systems 114.

In accordance with various embodiments, the inventory management server processor 210 removes the image of the product (‘PRODUCT 4’) overlaid on the virtual slot 502-4 of the graphical representation 500 when the trading status of the product is updated. To this end, as shown in FIG. 7, the inventory management server processor 210 executes the ESB module 218 to transmit a message to the inventory database 112 to update/delete the position data of the physical slot 402-4 associated with the sold product (‘PRODUCT 4’) from the product information associated with the product identifier, at 716. Upon removal of the position data from the entry, the inventory management server processor 210 removes the image of the (‘PRODUCT 4’) overlaid on the virtual slot 502-4 corresponding to the physical slot 402-4 from the virtual slot 502-4 of the graphical representation 500. At 718, the inventory management server processor 210 sends a message to the POS system 114 of the physical store storing/displaying the product to remove the product from the physical slot 402-4 of the grid 400 and another message to the buyer confirming the purchase.

In accordance with various embodiments, once the product is removed from the physical slot 402-4 of the grid 400, in some embodiments, the physical slot 402-4 of the grid 400 is utilized to store/display another product that is offered for sale. The inventory management server processor 210 then associates the position data of the physical slot 402-4 with another product identifier of the other product in the inventory database 112, using the process described above. Once the position data of the physical slot 402-4 with the other product identifier of the other product, the inventory management server processor 210 also updates the graphical representation 500 to overlay an image of the other product on the virtual slot 502-4 corresponding to the physical slot 402-4, using the process described above. The updated graphical representation 500 with the image of the other product overlaid on the virtual slot 502-4 is then displayed on the user device 108, when the inventory management server 110 receives the request from the user device 108.

Although the method 800 for the inventory management is described for a single product (‘PRODUCT 4’) displayed/stored in the physical store 102-1, a person skilled in the art would appreciate that the above-described steps of displaying, listing, storing, generating, receiving, overlaying, displaying, and updating are repeated for each of the plurality of products that are available for sale at each of the one or more physical stores 102.

The system and the method of the present disclosure are directed towards managing an inventory of a product across the one or more physical stores 102 and the one or more online sales platforms 106. The present disclosure provides a simple and efficient process to effectively synchronize the trading status of the product between the one or more physical stores 102 and the one or more online sales platforms 106. By generating the graphical representation 500 corresponding to the grid 400 of the physical store 102 and updating it to reflect the availability of the product, enables the customers to view the products available for sale in real-time on their user device 108 without any assistance thereby preventing any disappointment associated with selecting a product for purchase and then realizing during the billing that the product is already sold. Moreover, the ESB module 218 of the inventory management server 110 helps achieve better and quick synchronization between the multiple POS systems 114 and the one or more online sales platforms 106. The synchronization between these platforms leads to the reduction of unwanted delays in the updation of the trading status of the product.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the description. This method is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for inventory management of a one-of-a-kind product with a single quantity across at least one physical store and one or more online sales platforms, the system comprising:
the at least one physical store for displaying the product for sale, the at least one physical store including a grid with multiple physical slots, wherein the product is inserted in a physical slot of the multiple physical slots in the grid for display;
the one or more online sales platforms, each of the one or more online sales platforms configured to list a product identifier associated with the product for sale on their respective websites;
an inventory database configured to associate and store product information of the product with the product identifier, the product information including a trading status and physical location of the product, wherein the physical location indicates position data of the physical slot in the grid;
an inventory management server communicatively coupled to the inventory database and the one or more online sales platforms, the inventory management server configured to:
generate a webpage including a graphical representation of the grid of the physical store, the graphical representation includes a plurality of virtual slots corresponding to the multiple physical slots in the grid, wherein the positioning of each of the plurality of virtual slots in the webpage corresponds to the actual positioning of the corresponding multiple physical slots in the grid;
receive position data of the physical slot having the product inserted;
overlay an image of the product on a virtual slot of the plurality of virtual slots in the webpage corresponding to the physical slot;
display, on a user device, the webpage with the image of the product overlaid on the virtual slot of the webpage upon receiving a request from the user device; and
update the trading status of the product associated with the product identifier on the one or more online sales platforms and in the inventory database when the product is sold in any one of the online platforms or the physical store, wherein updating the trading status includes removing the image of the product from the virtual slot of the webpage displayed on the user device.

2. The system of claim 1, wherein the inventory management server includes:
an Enterprise Service Bus (ESB) module including one or more processes, each process is associated with a unique online sales platform of the one or more online sales platform for communications corresponding to the sale of the product associated with the product identifier on the online sales platform, wherein the ESB module is configured to:
receive data corresponding to the sale of the product associated with the product identifier from an online sales platform of the one or more online sales platforms;
analyze the received data corresponding to the sale of the product associated with the product identifier based on a process of the one or more processes associated with the online sales platform; and
update the trading status of the product associated with the product identifier across the remaining online sales platforms of the one or more online sales platforms and in the inventory database based on the analyzed data corresponding to the sale of the product.

3. The system of claim 1, wherein the inventory management server is further configured to:
generate and associate the webpage with a webpage identifier including one or more of a Quick Response (QR) code, a Uniform Resource Locator (URL) link associated with the webpage, and a Near Field Communication (NFC) tag, wherein the webpage is displayed on the user device when the user device accesses the webpage identifier.

4. The system of claim 3, wherein the webpage identifier is displayed in the at least one physical store to access the webpage corresponding to the grid of the at least one physical store.

5. The system of claim 1, wherein the system further includes:
a Point of Sale (POS) system associated with the at least one physical store and communicatively coupled to the inventory management server, wherein the POS system is configured to notify the inventory management server when the product associated with the product identifier is sold in the at least one physical store.

6. The system of claim 5, wherein the inventory management server is further configured to update the trading status of the product associated with the product identifier in the POS system when the product associated with the product identifier is sold in any one of the online platforms or the at least one physical store.

7. The system of claim 6, wherein the POS is further configured to:
deny, using the POS, sale of the product associated with the product identifier when the trading status of the product associated with the product identifier is updated.

8. The system of claim 1, wherein the inventory management server is configured to update the trading status by:
deleting the position data of the physical slot from the product information associated with the product identifier in the inventory database;
associating the position data of the physical slot with another product; and
displaying the webpage with an image of the other product overlaid on the virtual slot corresponding to the physical slot.

9. The system of claim 1, wherein the system further includes:
one or more additional physical stores, each physical store having a Point of Sale (POS) system communicatively coupled to the inventory management server, wherein each POS system is configured to perform one or more functions of:
notifying the inventory management server when the product associated with the product identifier is sold in a corresponding physical store of the one or more physical stores; or
receiving a notification to update the trading status of the product associated with the product identifier and deny the sale of the product associated with the product identifier when the product associated with the product identifier is sold in the at least one physical store or the one or more online sales platform.

10. A method for inventory management of a one-of-a-kind product with a single quantity across at least one physical store and one or more online sales platforms, the method comprising:
displaying, at the at least one physical store, the product for sale, the at least one physical store including a grid with multiple physical slots, wherein the product is inserted in a physical slot of the multiple physical slots in the grid for display;
associating and storing, in an inventory database, product information of the product with a product identifier associated with the product, the product information including a trading status and physical location of the product, wherein the physical location indicates position data of the physical slot in the grid;
listing, on the one or more online sales platforms, the product identifier associated with the product for sale on their respective websites;
generating, by an inventory management server, a webpage including a graphical representation of the grid of the physical store, the graphical representation includes a plurality of virtual slots corresponding to the multiple physical slots in the grid, wherein the positioning of each of the plurality of virtual slots in the webpage corresponds to the actual positioning of the corresponding multiple physical slots in the grid;
receiving, by the inventory management server, position data of the physical slot having the product inserted;
overlaying, by the inventory management server, an image of the product on a virtual slot of the plurality of virtual slots in the webpage corresponding to the physical slot;
displaying, by the inventory management server, on a user device, the webpage with the image of the product overlaid on the virtual slot of the webpage upon receiving a request from the user device; and
updating, by the inventory management server, the trading status of the product associated with the product identifier on the one or more online sales platforms and in the inventory database when the product is sold in any one of the online platforms or the physical store, wherein updating the trading status includes removing the image of the product from the virtual slot of the webpage displayed on the user device.

11. The method of claim 10, wherein the method further comprises:
generating and associating the webpage with a webpage identifier including one or more of a Quick Response (QR) code, a Uniform Resource Locator (URL) link associated with the webpage, and Near Field Communication (NFC) tags, wherein the webpage is displayed on the user device when the user device accesses the webpage identifier.

12. The method of claim 11, wherein the webpage identifier is displayed in the at least one physical store to access the webpage corresponding to the grid of the at least one physical store.

13. The method of claim 10, further comprising:
associating a Point of Sale (POS) system with the at least one physical store, wherein the POS system notifies the inventory management server when the product associated with the product identifier is sold in the at least one physical store.

14. The method of claim 13, further comprising:
updating the trading status of the product associated with the product identifier in the POS system when the product associated with the product identifier is sold in any one of the online platforms or the at least one physical store.

15. The method of claim 14, wherein the method further comprises:
denying, using the POS, sale of the product associated with the product identifier when the trading status of the product associated with the product identifier is updated.

16. The method of claim 10, wherein the method further comprises:
deleting the position data of the physical slot from the product information associated with the product identifier in the inventory database;
associating the position data of the physical slot with another product; and
displaying the webpage with an image of the other product overlaid on the virtual slot corresponding to the physical slot.

17. The method of claim 10, wherein the steps of displaying, storing, listing, generating, receiving, overlaying, displaying, and updating are repeated for a plurality of products.

18. An inventory management server for inventory management of a one-of-a-kind product with a single quantity across at least one physical store and one or more online sales platforms, the inventory management server comprising:
an inventory management server memory configured to store one or more instructions; and
an inventory management server processor communicatively coupled to the inventory management server memory, wherein the inventory management server processor is configured to execute the one or more instructions stored in the inventory management server memory to:
provide instructions to list a product identifier associated with the product for sale on the one or more online sales platforms;
associate and store, in an inventory database, product information of the product with the product identifier, the product information including a trading status and physical location of the product, wherein the physical location indicates position data corresponding to a location of a physical slot associated with the product in a grid of the at least one physical store;
generate a webpage including a graphical representation of the grid of the physical store, the graphical representation includes a plurality of virtual slots corresponding to multiple physical slots in the grid, wherein the positioning of each of the plurality of virtual slots in the webpage corresponds to actual positioning of the corresponding multiple physical slots in the grid;
receive position data of the physical slot associated with the product;
overlay an image of the product on a virtual slot of the plurality of virtual slots in the webpage corresponding to the physical slot;
display, on a user device, the webpage with the image of the product overlaid on the virtual slot of the webpage upon receiving a request from the user device; and
update the trading status of the product associated with the product identifier on the one or more online sales platforms and in the inventory database when the product is sold in any one of the online platforms or the physical store, wherein updating the trading status includes removing the image of the product from the virtual slot of the webpage displayed on the user device.

19. The inventory management server of claim 18, wherein the inventory management server processor is further configured to:
generate and associate the webpage with a webpage identifier including one or more of a Quick Response (QR) code, a Uniform Resource Locator (URL) link associated with the webpage, and Near Field Communication (NFC) tags, wherein the webpage is displayed on the user device when the user device accesses the webpage identifier displayed in the at least one physical store.

20. The inventory management server of claim 18, wherein the inventory management server processor is further configured to:
associate a Point of Sale (POS) system with the at least one physical store, wherein the POS system notifies the inventory management server when the product associated with the product identifier is sold in the at least one physical store.
